(19) United States
(12) Patent Application Publication
(10) Pub. No.: US 2008/0084239 A1
(43) Pub. Date: Apr. 10, 2008

(54) Regulated charge pump circuit

(75) Inventors: Richard Oswald, San Jose, CA (US); Tamotsu Yamamoto, Cupertino, CA (US); Syusaku Goto, Kyoto (JP)

Correspondence Address: MCDERMOTT WILL & EMERY LLP, 600 13TH STREET, NW, WASHINGTON, DC, 20005-3096, US

(73) Assignee: MATSUSHITA ELECTRIC INDUSTRIAL CO., LTD.

(21) Appl. No.: 11/898,134

(22) Filed: Sep. 10, 2007

Related U.S. Application Data
(60) Provisional application No. 60/842,986, filed on Sep. 8, 2006.

(51) Int. Cl. G05F 1/10

(52) U.S. Cl. 327/536

(57) ABSTRACT

A charge pump voltage regulator for converting an input voltage to an output voltage. The regulator includes an input terminal, an output terminal and a common terminal, with the input voltage being received across the input terminal and the common terminal, and the output voltage being produced across the output terminal and the common terminal. The regulator also includes a charge pump circuit coupled to the input terminal, the output terminal and the common terminal, which is operable in a plurality of modes for transferring energy between the input terminal and the output terminal; an output detector circuit for determining a regulation condition in which an output voltage is within a desired range; an oscillator circuit for producing a clock signal; a control circuit coupled to the output detector circuit and the oscillator circuit and operable for selectively operating the charge pump circuit in 3 or more modes, each of which produces a particular ratio between the input voltage and the output voltage, where the control circuit receives input signals from the output detector circuit and the oscillator circuit and selects one of the modes for operating the charge pump circuit based on the input signals.

### CLAIM OF PRIORITY

This patent application, and any patent(s) issuing therefrom, claims priority to U.S. provisional patent application No. 60/842,986, filed on Sep. 8, 2006, which is incorporated herein by reference in its entirety.

### FIELD OF THE INVENTION

This disclosure relates to a circuit and method for regulating a voltage by means of a charge pump circuit. The circuit and method allow for implementation of a regulator that maintains a particular voltage variable within required limits over varying input voltage levels, output voltage and load current levels at a high level of power efficiency.

### BACKGROUND OF THE INVENTION

DC/DC converters are widely used for converting input power supply voltages to different voltage values in order to improve the power efficiency and to stabilize variations in output voltage. In some applications it is preferable to use capacitors rather than inductors for energy transfer. Example circuits for this type of converter are described in the following figures.

FIG. 18A is a block diagram of a 2 times mode charge pump. A clock (CLK) is input to a Switch Control block. The Switch Control block controls SW1 and SW2 to charge a transfer capacitor (CFL) from an input voltage (VIN) and to discharge (or transfer the charge of) the CFL to an output capacitor (Cout). The voltage across the CFL is nearly VIN during each cycle of switch operation so that VOUT becomes VIN times 2.

FIG. 18B is a block diagram of 1.5 times mode charge pump. Once again, a clock (CLK) is input to a Switch Control block. The Switch Control block controls SW1 to SW4. During the first phase of the clock, the switches are configured to charge transfer capacitors CFL1 and CFL2 in series from the input voltage (VIN). The node voltage between the CFL1 and CFL2 becomes VIN/2 if the values of CFL1 and CFL2 are equal because they form a capacitor divider. During the second phase of the clock the Switch Control block configures the switches to discharge or transfer the charge of capacitors CFL1 and CFL2 in parallel to an output capacitor (Cout). The voltage across each of CFL1 and CFL2 is VIN/2, so VOUT becomes VIN times 1.5.

FIG. 18C is a block diagram of a combined 1.5 times and 2 times mode charge pump. During the first or charge phase of the clock (CLK) the Switch Control block configures SW1 to SW7 to charge CFL1 and CFL2 from VIN as described previously, in series for 1.5×mode (SW1, SW4, SW7=ON; SW2, SW3, SW5=OFF) or in parallel for 2×mode (SW1, SW3, SW5 and SW7 are ON and SW2, SW4 and SW6 are OFF).

During the second or discharge phase of the clock (CLK) the Switch Control block always configures SW2, SW3, SW5 and SW6 to ON and SW1, SW4 and SW7 to OFF. This causes

$$VOUT = VIN + VCFL = VIN + \frac{VIN}{2}$$

for 1.5×mode and VIN+VIN for 2×mode.

Since a charge pump type DC/DC converter uses capacitors as the energy transfer element, the input voltage to output voltage ratio is determined by the structure of the transfer capacitors. For example, the ratio VOUT/VIN is 2.0 for the circuit configuration of FIG. 18A and VOUT/VIN is 1.5 for the circuit configuration of FIG. 18B. This ratio is limited to rational fractions and thus is not flexible, since the voltage is correlative to the physical number of capacitors.

As is clear from the foregoing, prior art charge pump circuits are known in the art. One specific example of a charge pump circuit is illustrated in U.S. Pat. No. 6,512,411 (see, e.g., FIG. 4 of the '411 patent), which illustrates a buck mode charge pump configuration. It is noted that this circuit can also be changed to a boost configuration.

The '411 patent also provides a control method for choosing between 2 or more charge pump input to output conversion ratios in order to maintain VOUT within a range of values, at good efficiency, regardless of changes in VIN or the amount of load.

In the case of using a battery as the input power supply, the input voltage, VIN, drops with the discharge of the battery, and therefore the output voltage variation may be large in such a device. This degrades efficiency, because the output voltage is higher than the minimum required voltage in some range of input and output voltage due to the limited voltage ratios available.

As such, it is desirable to obtain a charge pump circuit which provides a regulated output voltage and which exhibits improved efficiency at the same time.

### SUMMARY OF THE INVENTION

In view of the foregoing, it is a primary objective of the present invention to provide a charge pump circuit capable of providing a regulated output voltage which simultaneously provides for improved efficiency. As explained in further detail below, this is accomplished by providing additional control circuitry so as to allow for increased control of the input voltage and output voltage ratio.

According to one embodiment, the present invention relates to a charge pump voltage regulator for converting an input voltage to an output voltage. The regulator includes an input terminal, an output terminal and a common terminal, with the input voltage being received across the input terminal and the common terminal, and the output voltage being produced across the output terminal and the common terminal. The regulator also includes a charge pump circuit coupled to the input terminal, the output terminal and the common terminal and comprising a plurality of switches and capacitors operable in a plurality of modes for transferring energy between the input terminal and the output terminal; an output detector circuit for determining a regulation condition in which an output voltage is within a desired range; an oscillator circuit for producing a clock signal; a control circuit coupled to the output detector circuit and the oscillator circuit and operable for selectively operating the charge pump circuit in 3 or more modes, each of which produces a particular ratio between the input voltage and the output voltage, where the control circuit receives input signals from the output detector circuit and the oscillator circuit and selects one of the modes for operating the charge pump circuit based on the input signals.

The regulated charge pump hysteretic circuit of the present invention provides numerous advantages over the prior art. One advantage is that the present invention provides a charge pump type DC/DC converter with improved efficiency and regulated characteristics of the output voltage as compared to prior art devices. The regulated charge pump circuit of the present invention also has reduced output ripple and uses mostly logic circuits instead of analog in the controller, compared to most charge pump converters.

Additional objects, advantages, and novel features of the invention will become apparent to those skilled in the art upon examination of the following description, or may be learned by practice of the invention. While the novel features of the invention are set forth below, the invention, both as to organization and content, will be better understood and appreciated, along with other objects and features thereof, from the following detailed description taken in conjunction with the drawings.

### BRIEF DESCRIPTION OF THE DRAWINGS

The accompanying drawings, which are incorporated into and form a part of the specification, illustrate several aspects and embodiments of the present invention and, together with the general description given above and detailed description given below, serve to explain the principles of the invention. Such description makes reference to the annexed drawings. The drawings are only for the purpose of illustrating preferred embodiments of the invention and are not to be treated as limiting the invention.

FIG. 1 illustrates an example of a first exemplary embodiment of a regulated charge pump (a two mode case).

FIG. 2 illustrates a sequence of mode control for the regulated charge pump of FIG. 1.

FIG. 3 illustrates a timing chart for the regulated charge pump of FIG. 1.

FIG. 4 illustrates a second exemplary embodiment of a regulated charge pump (a three mode case).

FIG. 5 illustrates a sequence of mode control for the regulated charge pump of FIG. 4.

FIG. 6 illustrates a timing chart for the regulated charge pump of FIG. 4.

FIG. 7 illustrates a third exemplary embodiment of a regulated charge pump (a three mode case).

FIG. 8 illustrates a sequence of mode control for the regulated charge pump of FIG. 7.

FIG. 9 illustrates a timing chart for the regulated charge pump of FIG. 7.

FIG. 10 illustrates an exemplary mode change detection circuit.

FIG. 11 illustrates an exemplary mode change detection timing chart.

FIG. 12-A illustrates a timing chart showing the overall function for the case of 1×, 1.5× and 2× charge pump ratios.

FIG. 12-B illustrates a first requirement for the timer period.

FIG. 12-C illustrates a second requirement for the timer period.

FIG. 13-A illustrates an exemplary timer circuit comprising a counter.

FIG. 13-B illustrates an exemplary timer circuit comprising a current source, capacitor and comparator.

FIG. 14 illustrates the use of the regulated charge pump of the present invention in a LED driver application.

FIG. 15 is another embodiment of a regulated charge pump utilized in an LED application.

FIG. 16 and FIG. 17 illustrate higher level block diagrams of the embodiments of FIG. 14 and FIG. 15, respectively, and illustrate that regulated charge pumps having ratios other than those shown in FIGS. 14 and 15, can be utilized in the embodiments of FIGS. 16 and 17.

FIG. 18a-18c illustrate examples of the switch configurations providing certain ratios of VOUT/VIN.

### DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein: rather, these embodiments are provided so that this disclosure will be thorough and complete, and will fully convey the scope of the invention to those skilled in the art; like numbers refer to like elements throughout.

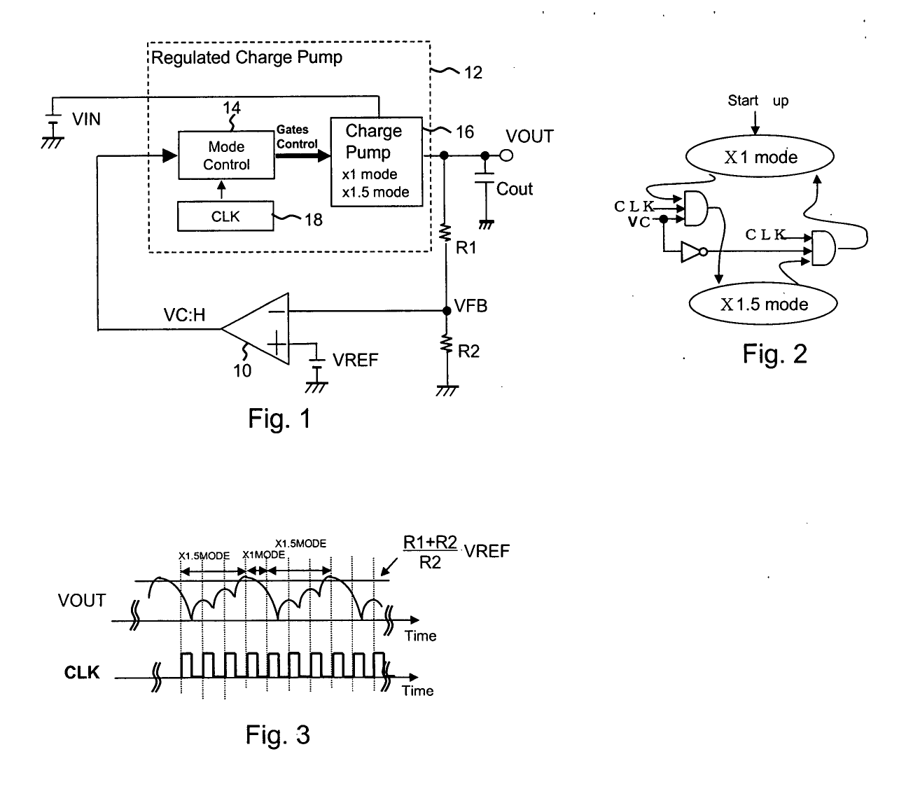

As noted above, FIG. 1 illustrates an example of a first embodiment of a regulated charge pump (a two mode case). FIG. 2 shows a sequencer for implementation of mode control for the regulated charge pump of FIG. 1, and FIG. 3 shows the relevant timing chart. Referring to FIG. 1, a comparator 10 is utilized to control the regulated charge pump 12. During operation, when the comparator output VC is H (high), a fraction of VOUT, which is set by the resistor divider comprising R1 and R2, is lower than the set point, VREF. As a result, the regulated charge pump ratio is changed from ×1 mode to ×1.5 mode. When the comparator output VC is L (low), VOUT is higher than the set point. As a result, the regulated charge pump ratio is changed from ×1.5 mode to ×1 mode. The relationship between VOUT and mode operation is shown in the timing chart of FIG. 3.

Referring again to FIG. 1, it is noted that the mode control circuit 14 receives a clock (CLK) 18 and provides gate control signals to the charge pump circuit 16. The gate control signal operates to place the charge pump in either the ×1 mode or the ×1.5 mode. Each mode has a minimum period of one clock cycle, because only one mode control change can occur at a rising edge of the CLK in the diagram shown in FIG. 2. The output voltage is regulated by change of mode between ×1 and ×1.5. In other words, for a given VIN the output voltage is determined by the duty ratio of the ×1 and ×1.5 modes.

The operation provides for maximum time of operation in ×1 mode and best efficiency, since the efficiency is determined by the duty of ×1 mode relative to ×1.5 mode. In the charge pump 16, the efficiency is higher when using lower transfer ratios, because the input current is the transfer ratio times the output current.

It is important to use lower transfer ratios in order to improve efficiency. As a result, the embodiment shown in FIG. 1 can provide for better efficiency than most prior art devices, as it can operate in a lower ratio mode for a larger fraction of the total time.

It is also noted that in the present embodiment, the VOUT voltage is controlled by changing the VREF voltage. It is further noted that while the embodiment of FIG. 1 has 2 modes of operation, a times 1 mode (×1) and a times 1.5 mode (×1.5), any combination of charge pump ratios can be utilized for each of the modes.

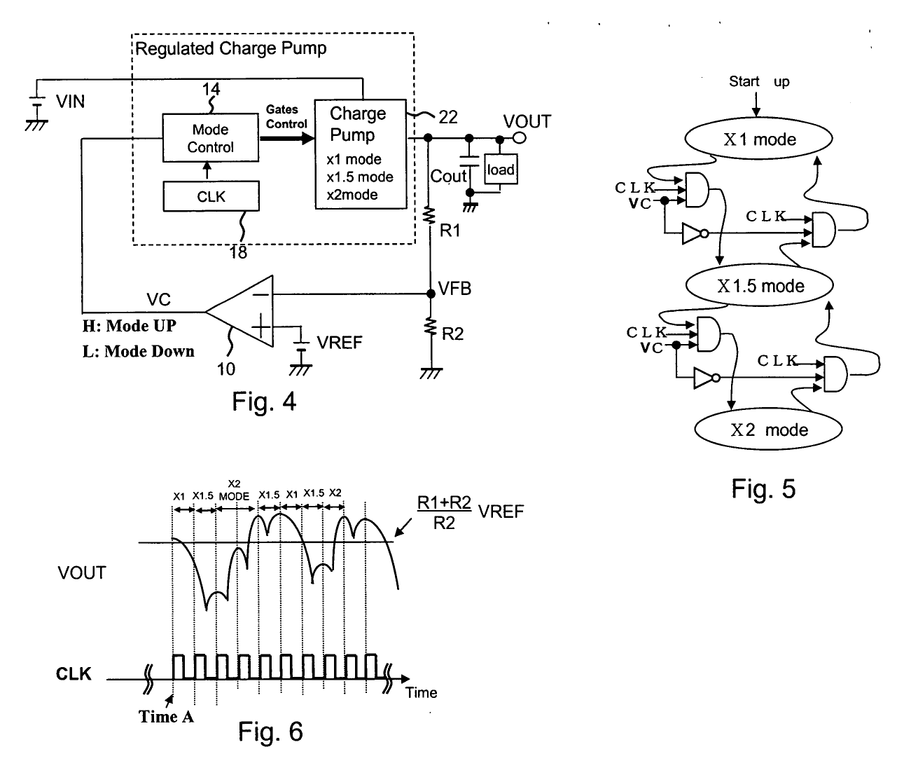

Another exemplary embodiment of the present invention, which is illustrated in FIG. 4, has 3 modes of operation. FIGS. 4, 5 and 6 illustrate this second embodiment and the operation thereof. It is noted that it is possible to provide on average a more efficient VIN to VOUT ratio by having 3 transfer ratios, especially in a battery operated application having large changes of VIN. The operation of the second embodiment is similar to the embodiment shown in FIG. 1. The main distinction is that a ×2 mode has been added to the charge pump circuit 22. Once again, the minimum period of any mode of operation is one clock cycle. FIGS. 5 and 6 illustrate an exemplary timing chart of VOUT and mode operation of the embodiment of FIG. 4.

Referring to FIGS. 5 and 6, the mode is ×1 at time A. The ×1 mode is the lowest transfer ratio available and VOUT is decreasing due to load 24. In the next clock cycle the mode changes to ×1.5 and VOUT starts increasing at the start of the transfer clock phase. However, VOUT is still lower than the set point voltage and comparator output VC stays H. In the next clock cycle the mode changes to ×2 mode even though VOUT is increasing. Thus, VOUT is increasing more rapidly than when in ×1.5 mode. As a result, this configuration operates as shown FIG. 6 and cycles through all modes. The voltage change of VOUT in one clock cycle varies with VIN, VOUT, load, clock frequency, and charge pump output impedance. It is noted that a cycle of transfer including three modes is not always predicable with this control method.

More specifically, because the minimum period of operation in each mode is 1 clock cycle, the transfer mode is changed to a higher ratio or lower ratio before the voltage change has settled and unstable operation results. As a result, VOUT exhibits a relatively large over-shoot or under-shoot voltage or non periodic ripple voltage. Such operation is unacceptable and efficiency is poor. When there are only 2 modes available, the device can only switch between 2 modes of operation, and therefore is inherently stable. However, when 3 or more modes are available, the device can exhibit unstable operation and such a large ripple voltage may not be acceptable in many applications.

As shown in FIG. 6, if the system is kept for several clock cycles in the ×1.5 mode after changing from ×1 mode, the over-shoot voltage is smaller and efficiency is improved due to operation on average in lower modes. After changing to ×1 mode, the charge pump needs to remain in ×1 mode for one cycle before allowing the next mode change to reduce the under shoot-voltage.

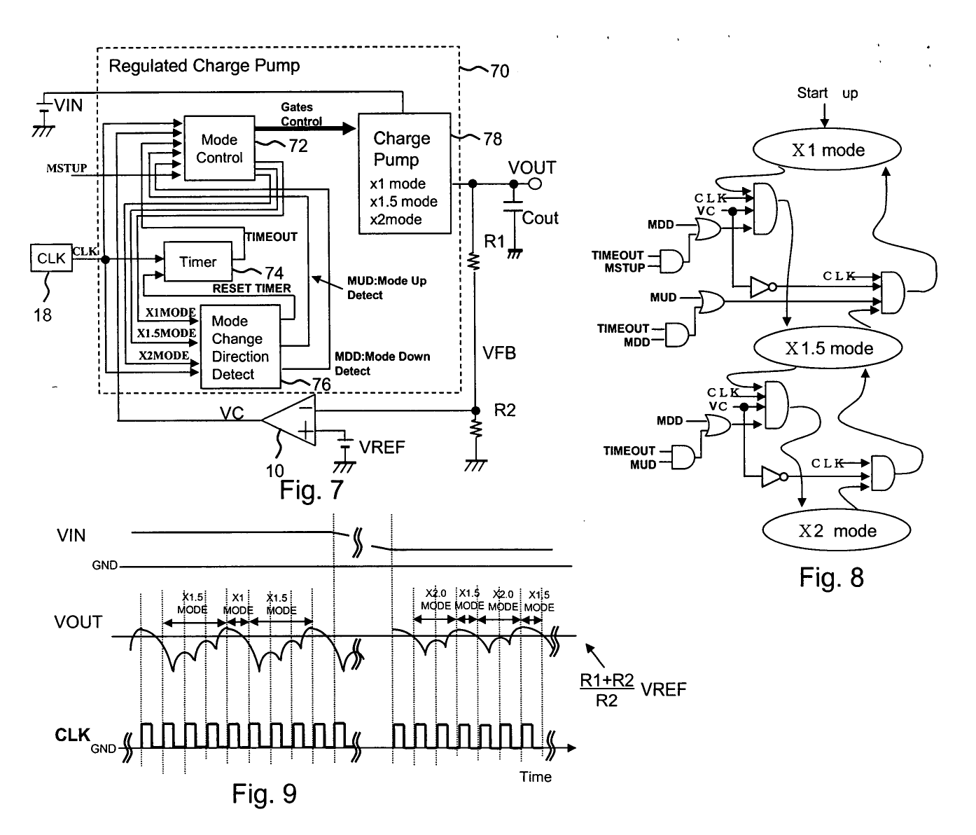

A third exemplary embodiment of the regulated charge pump of the present invention, which addresses some of the foregoing issues associated with the second embodiment, is illustrated in FIG. 7. FIG. 7 illustrates a regulated charge pump 70 capable of 3 transfer ratios. As explained further below, the regulated charge pump 70 of FIG. 7 provides an improvement with respect to the regulated voltage and efficiency as compared to a system with 2 transfer ratios over a wide range of external conditions and therefore provides better efficiency in battery operated applications.

Referring to FIG. 7, the regulated charge pump comprises a mode control circuit 72, a timer circuit 74, a mode change direction detection circuit 76 and a charge pump circuit 78. It is noted that the combination of the mode control circuit 72, the timer circuit 74 and the charge pump circuit 78 is also referred to herein as the control circuit. FIG. 8 illustrates an example mode control diagram and FIG. 9 illustrates an exemplary timing chart. In operation, the mode control circuit 72 provides gate control signals to a charge pump circuit 78 which implements the charge pump ratio modes. In addition, the mode control circuit 72 provides operation in each mode state by means of a mode change direction detection circuit 76, which provides input signals to mode control circuit 72.

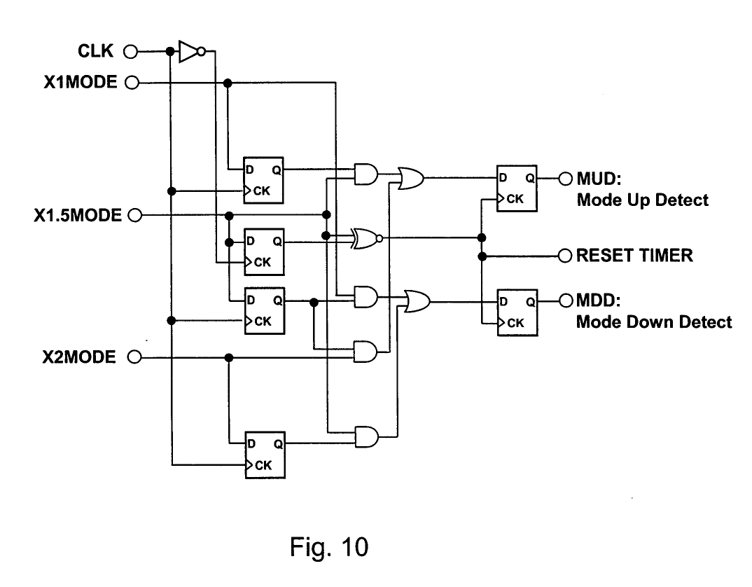

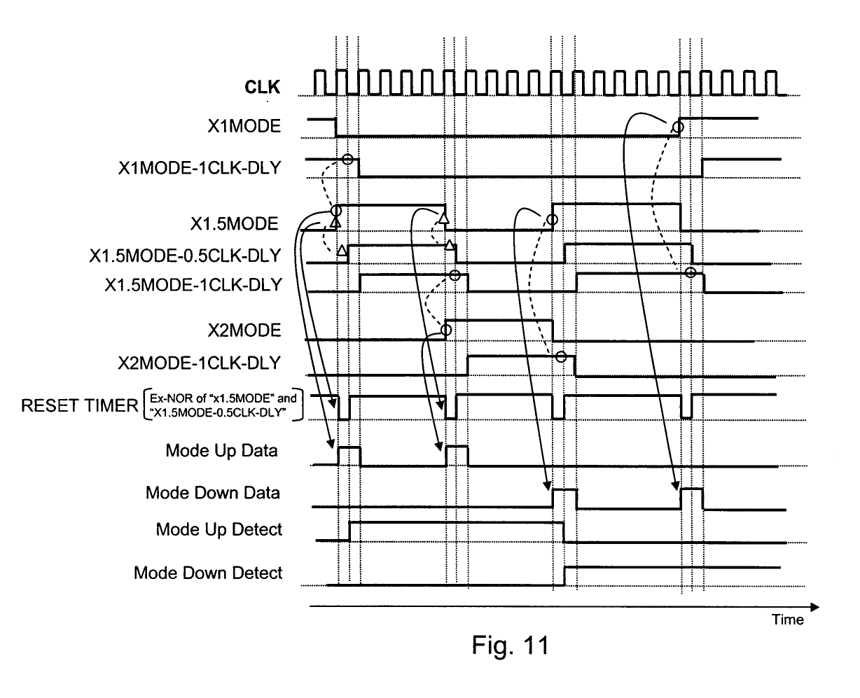

An exemplary mode change direction detection circuit 76 is shown FIG. 10 and the timing chart associated with the operation thereof is shown in FIG. 11. The mode change direction detection circuit 76 provides mode change direction information indicating whether the mode ratio has changed upward or downward. FIG. 10 illustrates an example implementation of the mode change direction detection circuit. However, the present invention is not limited to the implementation shown in FIG. 10, as there are numerous additional ways to implement the mode change direction detection circuit.

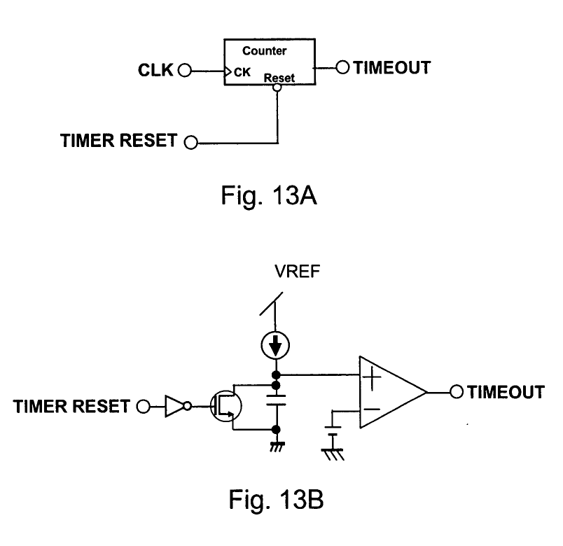

Exemplary timer circuits 74 are illustrated in FIG. 13A and FIG. 13B. The signal MUD (Mode Up Detect) indicates the occurrence of a mode ratio change in the upward direction, and the signal MDD (Mode Down Detect) indicates the occurrence of a mode ratio change in the downward direction. The mode change direction detection circuit 76 also generates a reset signal “RESET TIMER” which is utilized to reset the timer circuit 74.

During operation, the mode control circuit 72 receives output signals TIMEOUT from the timer circuit 74, MUD and MDD from the mode change direction detection circuit 76, VC from the comparator 10, a clock signal CLK from a clock input 18 and MSTUP from a start up circuit.

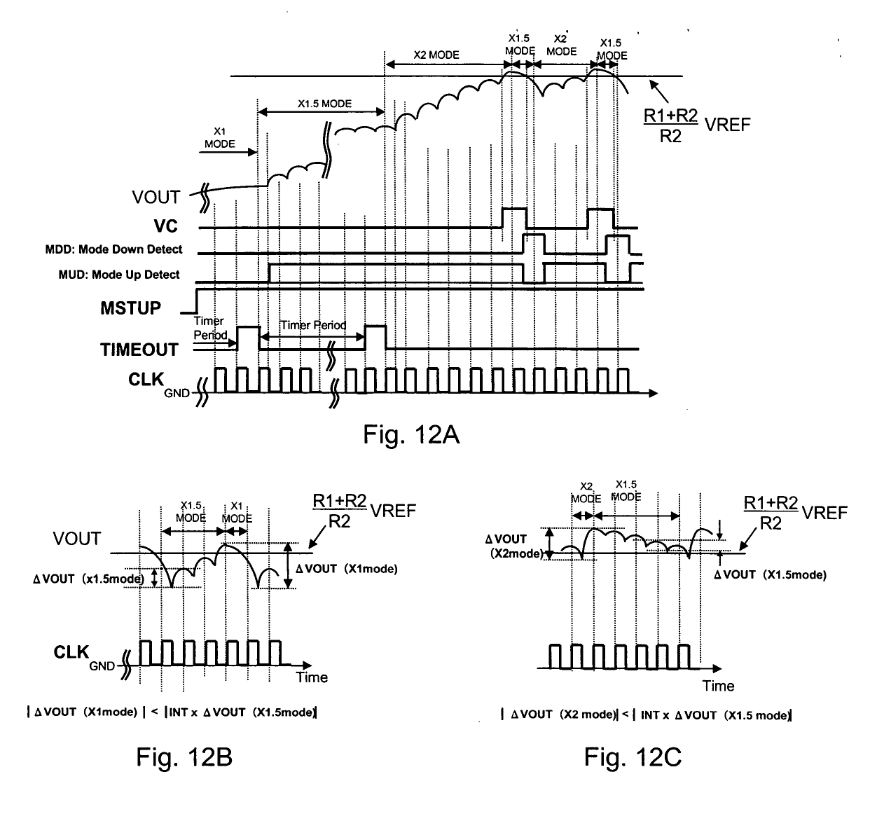

FIG. 12A illustrates a timing chart associated with the operation of this third embodiment of the charge pump having three ratio modes. An important aspect of the operation of the third embodiment is to prevent more than one mode change in the same direction in a given timer period, where a timer period is a predetermined count of an integer number of clock cycles. In the current embodiment, the timer period is 16 CLK or 32 CLK cycles with 1.2 MHz clock, which is a convenient number for logic implementation. The time required is a function of the variable in transfer ratios, VIN, VOUT, clock frequency. For example, if the previous mode change is from ×1 mode to ×1.5 mode, MUD becomes H, and as a result, the AND gate, which receives inputs TIMEOUT and MUD, prevents a change to ×2 mode in the same timer period even if VC is H. However, in the case where the previous mode change is from ×2 mod to ×1.5 mode, MDD is H, and the ×1.5 mode lasts a minimum of 1 CLK cycle. As a result, the regulated charge pump 70 provides low ripple voltage while allowing for a combination of modes. FIG. 12B and FIG. 12C show the requirement of the timer period, which is necessary for stable operation.

Referring to FIG. 12B, the ΔVOUT (×1 mode) and the ΔVOUT (×1.5 mode) is the incremental change in value of VOUT during one cycle of each mode. INT=(timer period/CLK period)=(timer period×fCLK) is the clock cycle count in the timer period, and is an integer number. The following equation indicates the required minimum timer period before a second transition to a higher ratio mode:
|ΔVOUT (×1MODE)|<|INT×ΔVOUT(×1.5MODE)|
FIG. 12C shows operation when transitioning to a lower ratio mode. The following equation indicates the required minimum timer period before a second transition to a lower ratio mode:
|ΔVOUT(×2 mode)|<|INT×ΔVOUT(×1.5mode)|
where “INT” in the first equation is the value giving the minimum timer period for stable operation when the previous mode transition was to a higher ratio mode and can be referred to as “INTUP”.

Similarly, “INT” in the second equation is the value giving the minimum timer period for stable operation when the previous mode transition was to a lower ratio mode and can be referred to as “INTDN”.

If only one value of INT is to be used for all cases it must be the largest of INTUP and INTDN. However the transient response of the regulator of FIG. 7 might be faster if the values for INT of INTUP and INTDN were used in the timer circuit 74 depending upon whether MUD or MDD, as shown in FIGS. 7 to 10, were asserted. The required timer period is a function of VIN, VOUT, clock frequency, charge transfer ratio, load current, capacitor values and switch resistance.

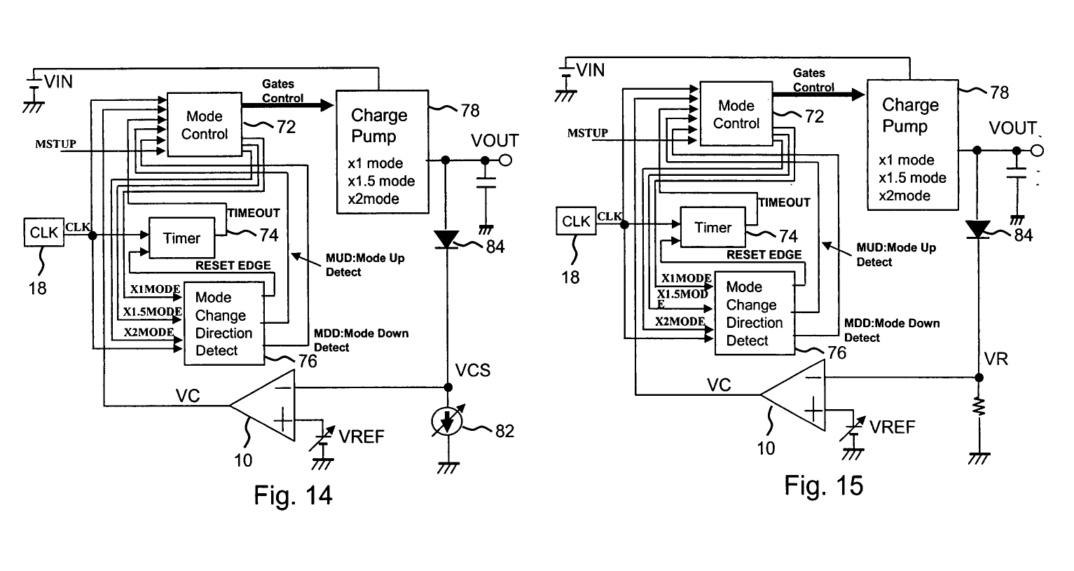

FIG. 14 illustrates an exemplary use of the regulated charge pump of the present invention in an application for an LED driver. Referring to FIG. 14, the diode current (i.e., LED current) is controlled by a current sink 82 coupled to the diode 84, and its value is changed in accordance with the desired brightness of the LED. Voltage VCS is regulated and its required value is determined in accordance with expected variations in VOUT and in the LED diode voltage. The diode voltage has relatively large variations due to temperature, load current and manufacturing variations. By utilizing voltage VCS as one input to the comparator which provides an input to the mode control circuit of the regulated charge pump, variations in both VOUT and the LED voltage are accounted for. By controlling VREF voltage, it is possible to always operate with adequate current sink head room and optimize efficiency.

FIG. 15 is another embodiment of regulated charge pump utilized in an LED application. The embodiments of FIG. 14 and FIG. 15 are similar, however in this embodiment, the current sink is eliminated and the LED current is directly controlled by voltage, VR. The use of a resistor as opposed to a current sink provides a cost savings, if greater variations in LED current are acceptable.

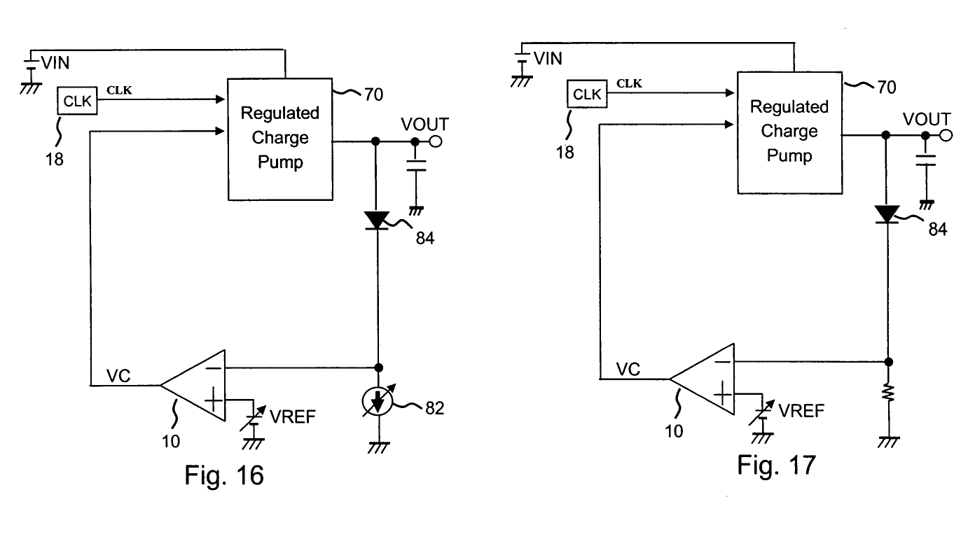

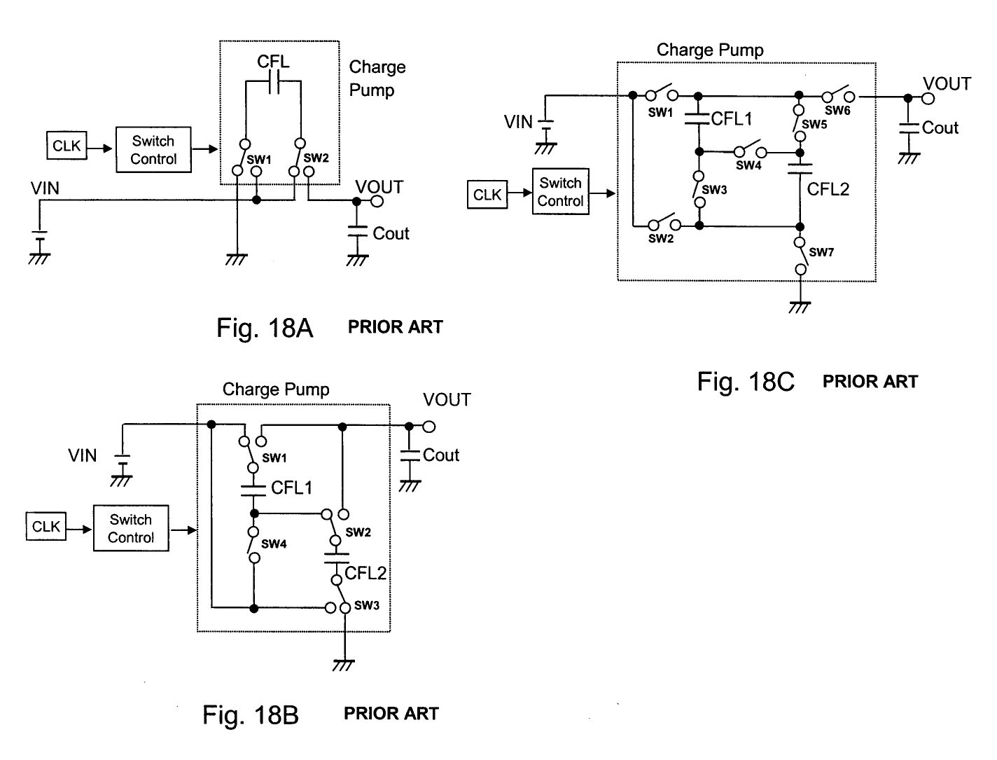

FIG. 16 and FIG. 17 illustrate higher level block diagrams of the embodiments of FIG. 14 and FIG. 15, respectively, and are intended to illustrate that regulated charge pumps other than those shown in FIGS. 14 and 15, can be utilized in the embodiments of FIGS. 16 and 17.

While specific embodiments of, and examples for, the invention are described herein for illustrative purposes, various equivalent modifications are possible within the scope of the invention, as those skilled in the relevant art will recognize.

It is intended that all matter contained in the above description and shown in the accompanying drawings shall be interpreted as illustrative and not in a limiting sense. It is also to be understood that the following claims are intended to cover all generic and specific features herein described and all statements of the scope of the various inventive concepts which, as a matter of language, might be said to fall there-between.

We claim:

1. A charge pump voltage regulator for converting an input voltage to an output voltage, the regulator comprising:
an input terminal, an output terminal and a common terminal, said input voltage being received across said input terminal and said common terminal and the output voltage being produced across said output terminal and said common terminal;
a charge pump circuit coupled to said input terminal, said output terminal and said common terminal, said charge pump circuit being operable in a plurality of modes for transferring energy between said input terminal and said output terminal;
an output detector circuit suitable for determining a regulation condition in which an output voltage is within a desired range;
an oscillator circuit for producing a clock signal;
a control circuit coupled to said output detector circuit and said oscillator circuit, said control circuit being operable for selectively operating said charge pump circuit in 3 or more modes, each of said modes producing a particular ratio between said input voltage and said output voltage;
said control circuit receiving input signals from said output detector circuit and said oscillator circuit and selecting one of said modes for operating said charge pump circuit based on said input signals.

2. The charge pump voltage regulator of claim 1, wherein said control circuit comprises a mode control circuit, a mode change direction detection circuit and a timer circuit, said mode control circuit being coupled to said charge pump circuit and provides input signals to said charge pump for controlling the mode of operation of said charge pump, said mode change direction detection circuit and said timer circuit being coupled to said mode control circuit and providing input signals to said mode control circuit.

3. The charge pump voltage regulator of claim 1, wherein said modes of operation of said charge pump circuit produces voltage step up, voltage step down or voltage inversion relationship between said input voltage and said output voltage.

4. The charge pump voltage regulator of claim 1, wherein said timer circuit and said mode change direction detect circuit of said control circuit are operable for delaying subsequent changes in said mode of operation of said charge pump circuit, when said changes would be in the same direction as the most recent previous mode change.

5. The charge pump voltage regulator of claim 1, wherein said output detector circuit includes a voltage reference circuit for producing a reference signal; a comparator receiving said reference signal and a signal related to said output voltage; said comparator producing a regulation signal utilized by said control circuit.

6. The charge pump voltage regulator of claim 1, wherein said timer circuit comprises a digital counter circuit utilizing said clock signal and an integer number divisor for producing a signal indicating an elapsed time, said timer circuit having an output coupled to said mode control circuit, said timer circuit providing said signal indicating the elapsed time to said mode control circuit.

7. The charge pump voltage regulator of claim 6, wherein said integer number divisor is assigned different values in order to optimize performance in each of said modes of said charge pump.
